(19) United States
(12) Patent Application Publication
(10) Pub. No.: US 2002/0138621 A1
(43) Pub. Date: Sep. 26, 2002

(54) System and method for displaying remotely stored content on a web page

(76) Inventors: Jan R. Rutherford, Littleton, CO (US); James M. Gile, Golden, CO (US); Theodore J. Waltman, Lakewood, CO (US); Jeroen Aarden, Basel (CH); Neil G. Peterson, Lafayette, CO (US)

Correspondence Address: Lloyd G. Farr, Nelson Mullins Riley & Scarborough, LLP, 1330 Lady Street, Columbia, SC, 29201, US

(21) Appl. No.: 09/780,188

(22) Filed: Feb. 8, 2001

(51) Int. Cl. G06F 15/16

(52) U.S. Cl. 709/227; 709/200

(57) ABSTRACT

A system and method provides, on a web page provided by a host server, content that resides on a server that is remote from the host server over a distributed computer system. A client computer requests and downloads a web page from the host server to the client computer, at which the requested web page is parsed. In response to an instruction parsed from the requested web page, the client computer downloads executable code is downloaded from a remote server specified in the instruction, and the client computer executes the code. Responsively to the executable code, content is downloaded from the remote server to the client computer and displayed on the requested web page.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention relates generally to methods and systems for providing content to a web site.

A web site comprises a collection of linked web pages resident on a host server that may be accessed by a browser. The web site could reside on the Internet, an intranet, an extranet or other network environment. Each web page within the web site is a text file containing Hypertext Markup Language (“HTML”) instructions regarding the layout of the web page. A web page may be accessed by a browser using the web page's Uniform Resource Locator (“URL”), which is essentially an address path identifying the server that hosts the desired web page and the location of the web page on the server.

With a browser, such as Internet Explorer™ or Netscape Navigator™, a user can send a request from a client computer to access a web page stored at a particular URL on a host server. When the host server receives the user's request, it sends the requested web page to the client computer, where the document is parsed by the browser and displayed. A communications protocol used in making such a request and in transferring web pages is the Hypertext Transfer Protocol (“HTTP”).

There are a multitude of devices and platforms that provide access to web sites. Since web browsers are available on a variety of such platforms and devices, most networks, particularly the Internet, can be accessed virtually anywhere. Furthermore, the network can be accessed not only with a general-purpose computer, but also with a handheld computer, cellular phone or internet appliance, such as a refrigerator, toaster, stove, or any other device with a network connection.

One factor in the commercial viability of a web site is its ability not only to attract users, but also keep users coming back to the web site. A site's ability to promote return users is commonly known as “stickiness.” To promote stickiness, the web site should contain useful content that piques the user's interest. Due to the costly time-intensive expenditure required to generate useful content, however, most web sites fail to maximize user retention. As a result, such sites may fail to realize their full value.

Due to the cost prohibitive nature of generating sufficient useful content to retain users, many web sites provide access to content available at other sites. In one common technique, a host site provides one or more links to other web sites that contain the desired information. While useful in providing content, a link moves the user from the host site to the site where the content resides and therefore necessarily reduces the amount of time the user actually spends on the host web site. That is, while the host site provides a link in order to increase its value to users, and thereby encourage users to visit the site, the link ultimately encourages users to leave.

Web sites also provide additional content through the use of frames. By framing a web site, the browser display is subdivided into two or more sections (frames), where the contents of each frame are taken from a different web page. Accordingly, the user may navigate information from other web sites within the frames without ever leaving the web site. Although frames provide flexibility in designing web pages, many designers avoid using frames because they are supported unevenly by current browsers. Moreover, users may have a tendency to go directly to the framed web sites rather than navigating through the frames.

### SUMMARY OF THE INVENTION

The present invention recognizes and addresses disadvantages of prior art constructions and methods.

Accordingly, it is an object of the present invention to provide an improved system and method for displaying content on web pages.

This and other objects may be achieved by a process for providing, on a web page provided by a host server, content that resides on a server that is remote from the host server over a distributed computer system. A web page requested from the host server is downloaded to a client computer, at which the requested web page is parsed. In response to an instruction parsed from the requested web page, executable code is downloaded to a client computer from a remote server specified in the instruction. The executable code is executed on the client computer. Responsively to the executable code, content is downloaded from the remote server to the client computer and displayed on the requested web page.

In a system for displaying, on a web page provided by a host server, content that resides on a server that is remote from the host server a distributed computer system, a host server is in communication with a client computer over the distributed computer system. A web page resides on the host server. The remote server is in communication with the client computer over the distributed computer system. Data is coupled to the remoter server. A browser at the client computer is configured to request, receive and parse the web page. First computer program code resides within the web page and is configured to establish, upon execution of the first code by the browser, a communication connection over the distributed computer system between the browser and the remote server and to request the content. Second computer program code resides at the remote server and is configured to receive the content request from the first code through the connection, to obtain the content from the data responsively thereto, and to forward the content to the browser. The first code is configured to display the content received from the second code on the web page.

The accompanying drawings, which are incorporated in and constitute a part of the specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended figures, in which:

FIG. 1 illustrates a network schematic of a system, according to an embodiment of the present invention;

FIG. 2 is a flow chart illustrating the steps of a method according to an embodiment of the present invention; and

FIGS. 3a-3f illustrate a user interface and content displayed on a requested web site according to an embodiment of the present invention.

Repeat use of reference characters in the present specification and drawings is intended to represent same or analogous features or elements of the invention.

### DETAILED DESCRIPTION OF THE PREFERRED EMBODIMENTS

Reference is made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can by made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

One or more of the preferred embodiments of the present invention as described below operates within and/or in conjunction with a distributed computing system. Generally, such a system includes multiple memory storage and computing devices located remotely from each other. The execution of program applications may occur at these remote computing sites as data is transferred among the memory devices and by between the computing devices over an extended system. Examples of distributed computer systems include the Internet, local and wide area networks, virtual private networks, and point-to-point systems. The Internet is a global accumulation of computer networks linked by routers that direct communication among the networks through an information retrieval system, most commonly the World Wide Web.

Certain operations and processes described herein are executed by one or more computers within a distributed computing system. As should be well understood, a computer transforms information in the form of electronic signals input into the computer to desired output. The input may be provided by a human operator, another computer, or from other external sources. To accomplish these functions in one computing environment, a conventional general purpose computer includes a processor, read-only and random-access memory, a bus system and input/output systems to transfer information within the computer and to interact with external devices. The computer's memory includes an operating system and various application programs that run on the operating system.

As noted above, the present invention provides content on a web page where the content resides on a server specified by the web page. Although the content server is remote from the host web page server, the content is seamlessly retrieved from data coupled to the remote server and is displayed on the web page at a client computer. In a preferred embodiment, the web page establishes a search interface to a database coupled to the remote server that allows the user to query the database and display the search results on the web page.

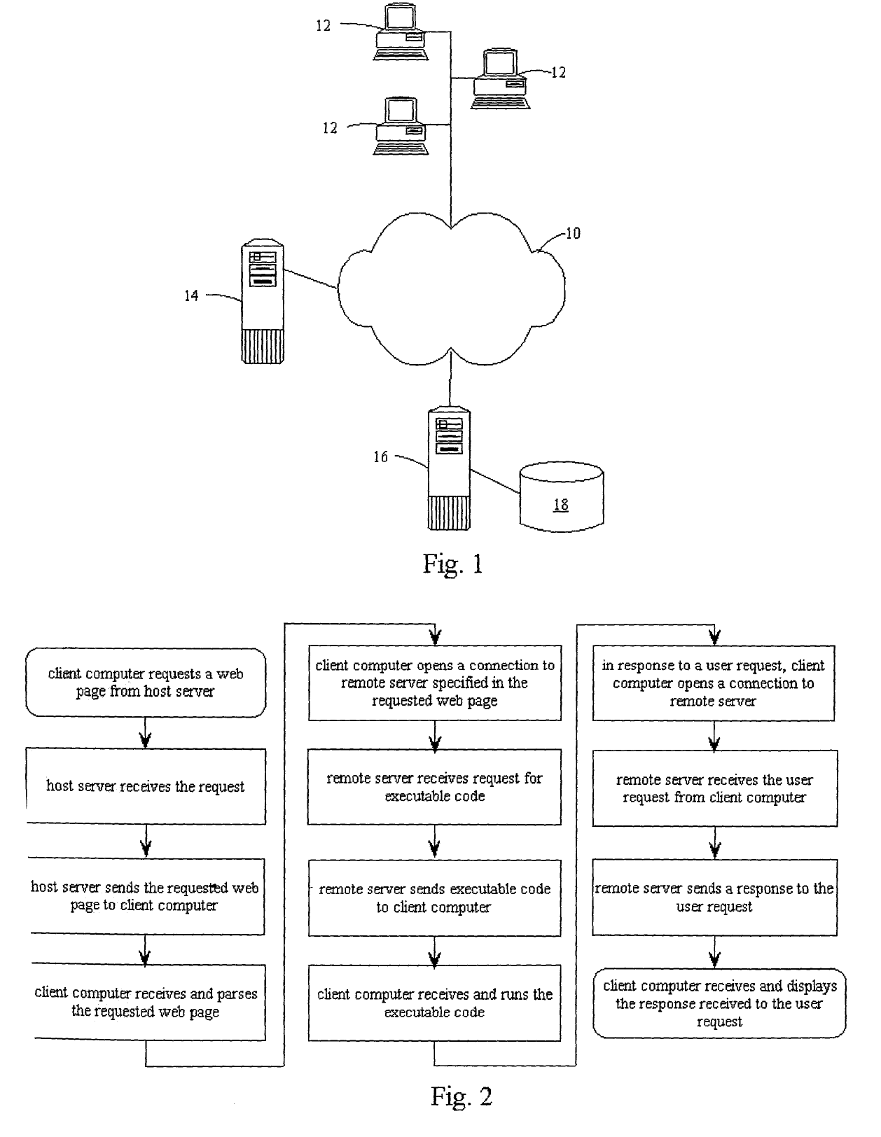

Referring to FIG. 1, for example, a distributed computing system includes a plurality of client computers 12 connected to a host server 14 and a remote server 16 via a network 10. Although FIG. 1 depicts the network 10 for exchanging data as the Internet, the present system is not limited to the Internet and may be implemented in the context of any network environment. Client computers 12 could be any network enabled device, such as a personal computer, a handheld computer, a cellular phone or the like. It will be clear to one of ordinary skill in the art that client computers 12, host server 14 and remote server 16 can be networked using numerous devices, platforms and network architectures.

Client computers 12 run browser software, such as Internet Explorer™, or Netscape Navigator™ that is able to communicate with both host server 14 and remote server 16. As should be understood in this art, browser software establishes a system path between the browser's computer and a server on the network, for example as identified by the server's URL. Through such a system path, the server may transfer web pages that include content such as text and graphic images, and sound and video files using a standard description language such as HTML. Although browser software communicates with host server 14 and remote server 16 preferably using HTTP, the present system and method could be adapted to networks that do not employ HTTP. Browser software preferably is also adapted to run executable code, such as a Java applet or ActiveX control. In the case of a Java applet, the browser preferably has a Java Virtual Machine to run executable code files. With an ActiveX control, the browser may have a plug specific to the executable code.

Host server 14 is capable of communicating with client computers 12, but need not necessarily communicate with remote server 16. Host server 14 runs web server software, such as Internet Information Server™ or Apache™, that is capable of responding to HTTP instructions from client computers 12. Host server 14 has at least one web page residing thereon that may be accessed by a client computer 12 using the web page's URL.

Remote server 16 is capable of communicating with client computers 12, but does not need to be able to communicate with host server 14. Like host server 14, remote server 16 runs web server software; however, remote server 16 need not have any web pages residing thereon. Instead, an executable code resides on remote server 16, and remote server 16 runs an application that handles requests from client computers 12 regarding the executable code at the client computers.

A business enterprise may employ a web site hosted by server 14 in pursuit of its business, for example providing access to information regarding medical services and medical service providers. The enterprise may desire in this case to also provide ancillary information, for example relating to pharmaceuticals, that may be of interest to its web site visitors but that may be prohibitively difficult for the enterprise to independently compile. Accordingly, in building its web site, the business enterprise may contact an appropriate content provider manually or through the content provider's web site and request the use of the desired content on its page.

The content provider makes the content available to the enterprise through instruction code manually written into the business enterprise's web page or downloaded from the content provider's web site and inserted into the web page code. The instruction code identifies the location of an executable code file that is configured to establish a connection between a client browser and remote server 16 and to request downloading of content from the remote server to the client browser. An exemplary HTML code instruction is as follows:

<applet code =“com.MyApplet.class”

archive =“MyApplet.jar”
codebase=“http://www.sample.com/applet”
height=“250” width=“145”
MAYSCRIPT>

</applet>

Any suitable instruction format may be used, and it should therefore be understood that this HTML example is provided for purposes of illustration only.

Referring to the example, “<applet” is an anchor opening for the identification of a Java executable code file “com.MyApplet.class” that utilizes the classes “MyApplet.jar.” The Java code and the classes are found at a server 16 address “http\\www.sample.com\applet”. The height and width definitions refer to screen dimensions within the client computer's browser window within which content conveyed by the executable code is displayed.

FIG. 2 provides a flow chart illustrating the communication between the client computers, the host server and the remote server. Referring also to FIG. 1, a client computer browser requests a web page from host server 14 through HTTP instructions using the web page's URL. Upon receiving the request, host server 14 sends an HTTP response containing the HTML for the requested page.

Referring to the instruction code example above, once client computer 12 receives the web page, the browser software parses the page's HTML code and recognizes that the HTML references an executable code file (“com.MyApplet.class”) that resides on a remote server 16 specified by the web page (at “http:\\www.sample.com\applet”). Responsively to the anchor, the client computer's browser establishes a new HTTP connection to the remote server 16 requesting the executable code file. Upon receiving the request, the remote server 16 sends the executable code file (in this case Java byte code) back to client computer 12, which then runs the downloaded code. With respect to the present Java example, the browser software loads the applet's java byte code and runs the applet in the browser's Java Virtual Machine (“JVM”).

The executable code may be configured to download content from remote server 16 through various suitable mechanisms. For example, the code may automatically download and display content without interaction by a client computer user. In a Java example, a downloaded applet automatically establishes an HTTP connection with the remote server over network 10 and communicates with a servlet at the remote server through the client computer's browser. The applet then requests content identified within the applet. The servlet queries database 18 for the identified content, obtains the content from the database and forwards the content over the HTTP connection to the applet at the client computer's browser. The applet then processes the content and displays the content at the window described in the HTML instruction.

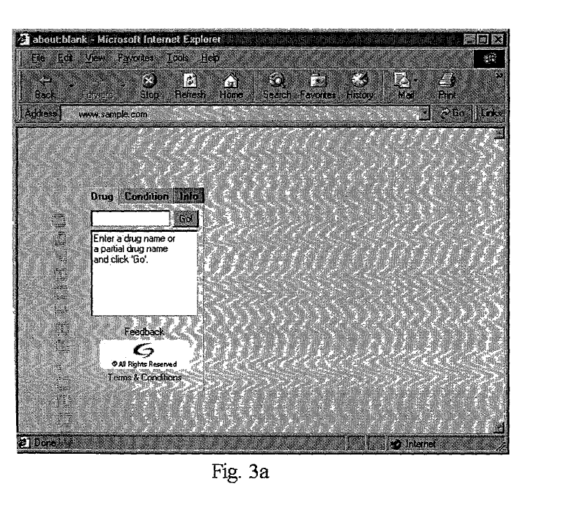

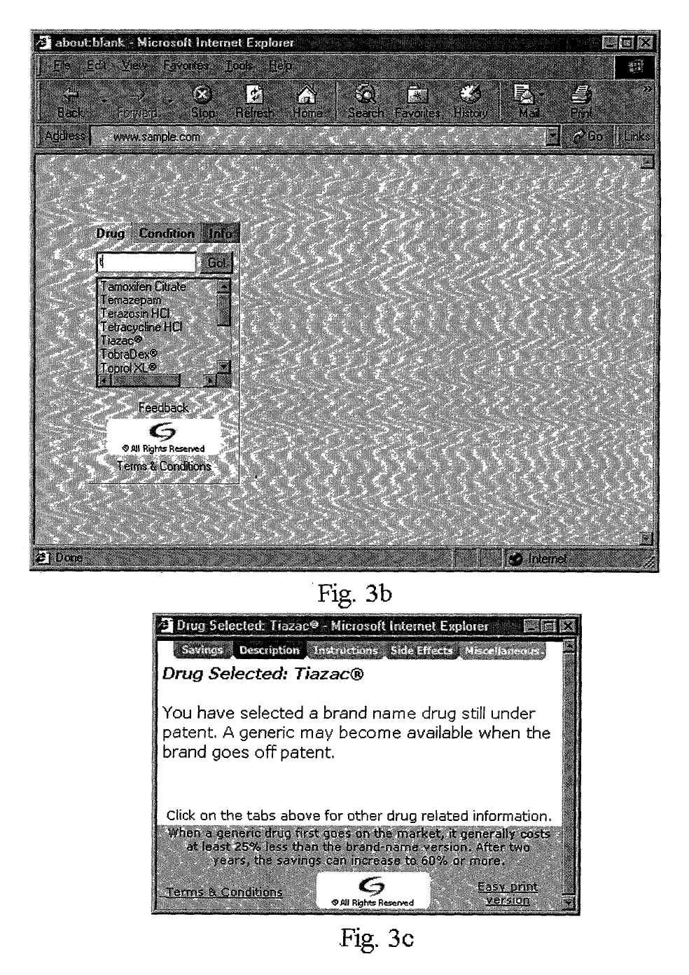

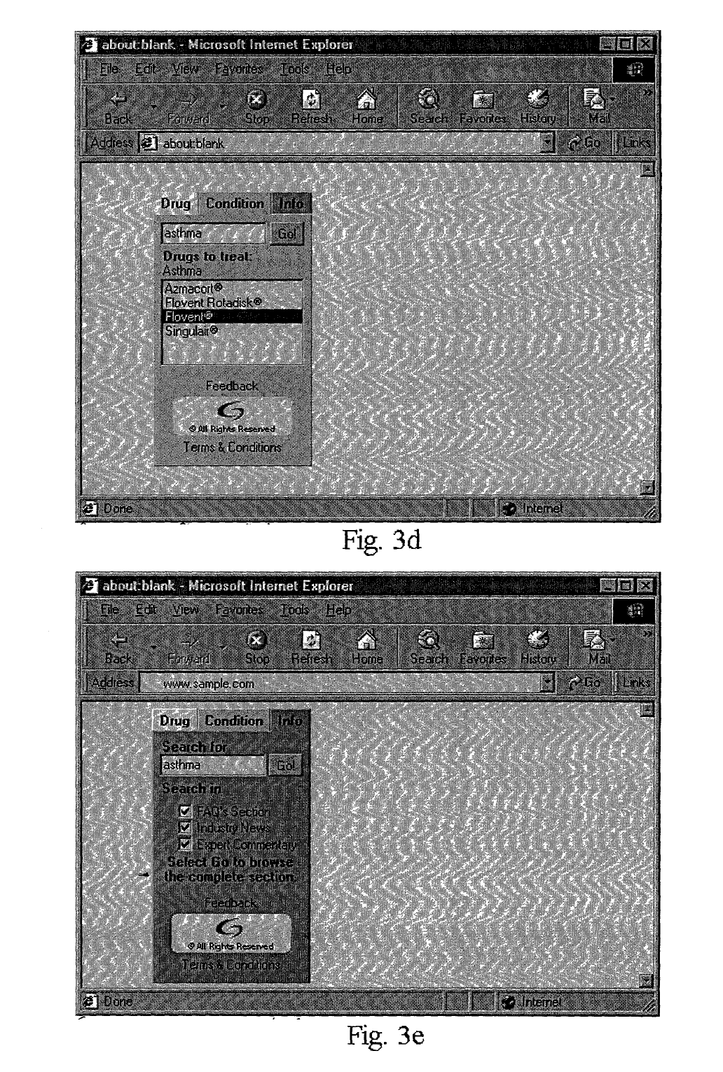

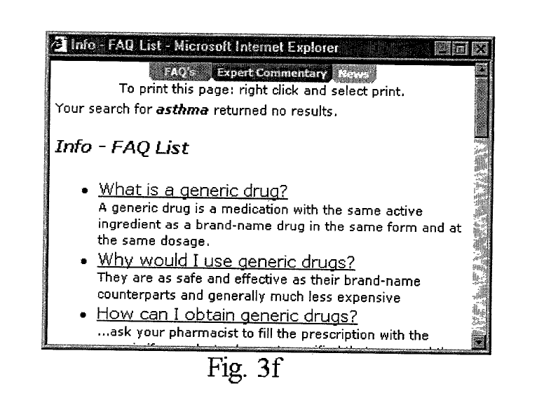

In the embodiment described with respect to FIG. 2, however, the applet generates and displays an interface, or an icon on the web page through which a user may activate the interface, at client computer 12 without automatically downloading content. Referring also to FIG. 3a, for example, the interface may be a search engine implemented in a Java byte code that presents an interface display screen 20 within a downloaded web page 22 (shown blank in FIG. 3a for clarity) as described by the HTML instruction. The code establishes an HTTP connection with the remote server only in response to user interaction with the interface.

Upon each request by the user entered through the displayed interface, the client computer's browser creates a new HTTP connection with remote server 16 and sends the appropriate search request information. This connection remains open until a servlet at the remote server returns a response or the applet specifically closes the connection. Upon receiving the search request from the search engine applet, the remote server's servlet retrieves the requested information from database 18 and forwards the requested content to client computer 12. The applet processes the content and displays the content on the web page at the client computer within the browser window as described in the HTML instruction.

It should be understood that the downloaded Java applet, or other type of code file, may establish other suitable types of interfaces. For example, the interface may comprise a template designed to receive order information from a user at the client computer. That is, the template may permit the user to download content regarding the content provider's products or services. If the user selects certain desired products or services, the template may permit the user to enter information identifying the user, requesting the desired products or services and indicating a method of payment. Each time the user requests or submits information, the applet transmits the request or submission to the remote server and requests appropriate information from the remote server to respond to the user. It should be understood that in such commercial transactions, the applet may establish a more secure connection, for example through Secure Sockets Layer communication.

It should be understood by those skilled in the art that the applet may be configured to establish a new HTTP connection with remote server 16 or any other server available on the network. If the applet is written as a signed applet, the applet may make a connection to any server residing on the network that accepts connections from the author of the applet. A signed applet is an applet whose source and integrity are guaranteed by its author. This is done by attaching a digital signature to the applet that indicates who developed the applet, when the applet was developed, and whether it has been tampered with since that time. Accordingly, the signed applet may reside at a server other than remote server 16, for example host server 14, and still retrieve content from the remote server. If the applet is written as an unsigned applet, however, the applet will be restricted to connecting to the remote server from which the applet was downloaded.

The executable code is called from an instruction embedded in the web page and is, therefore, encapsulated from the web page HTML. Thus, it is not necessary to reconstruct the web page at the client computer each time new content is called.

Regardless of the particular mechanism by which the executable code in such embodiments downloads information from the remote server to the client computer, the content is presented on the web page without providing the user access to other web sites. The code seamlessly gathers content from the remote server without notifying the user that the content originates anywhere other than the host server site. This reduces the user's tendency to navigate other web pages. Thus, the host enterprise may take advantage of the resources of an avid content provider while reducing the risk of losing visitors to its web site.

For purposes of illustration only, the following example illustrates the use of a search engine to provide remote web page content relating to pharmaceuticals and related medical information. Returning to FIG. 3a, the applet displays interface screen 20 within web page 22 (shown blank for purposes of clarity) on a browser window 24. As described above, the applet may present screen 20 automatically upon construction of the web page or may provide an icon within the web page which, upon activation by the user presents screen 20. A close button (not shown) may be provided on screen 20 to eliminate the screen and return the icon.

Screen 20 allows the user to select from three types of searchable information depending on whether the user selects a “Drug,” “Condition” or “Info” tab at the top of the screen. With the “drug” tab selected, as is shown in FIG. 3b, a plurality of drug names are loaded from remote server 16 by typing “t” in a text box and clicking a “Go” button. Activating the “Go” button causes the applet to establish an HTTP connection with the remote server. Responsive to the “t” request, a servlet at the remote server downloads a list of drugs meeting the request criteria. The browser applet displays the downloaded drugs in a content screen 26. Upon clicking on a desired drug, the interface applet establishes another HTTP connection with the remote server, requests predetermined information regarding the selected drug and displays the information in an information window 28 (FIG. 3c) placed over screen 20. More specific information regarding the drug may be retrieved by activating “Savings,” “Description,” “Instructions,” “Side Effects” and/or “Miscellaneous” buttons listed at the top of window 28. By choosing the “Savings” tab, for example, the user could learn that cost is significantly reduced by using a generic version of the drug. Once the user has reviewed information regarding the selected drug, the user may close the window and search for other drug information.

Upon selecting the “condition” tab at screen 20 (FIG. 3d), and entering a disease or symptom in the text box, activation of the “Go” button causes the applet to establish an HTTP connection with the remote server and download from the remote database a list of those drugs related to the submitted disease or symptom. The applet receives the list and displays the drugs in window 26. If the user clicks on one of the downloaded drugs, the applet displays a descriptive window 28 (FIG. 3c).

Upon choosing the “Info” tab, the applet presents the screen 20 shown in FIG. 3e. The user may enter a disease, condition or drug in the text box and indicate the sources that the user desires to search with respect to that term. Upon activating the “Go” button, the applet establishes an HTTP connection with the remote server and searches the selected area for the input term. The remote server applet searches the remote database and downloads the resulting content to the client computer applet, which displays the search results in a window 30 shown in FIG. 3f. initially, window 30 displays all items returned by the search. The user may, however, select subsets of the return search results by activating a desired button from the “FAQ's,” “Expert Commentary” or “News” buttons at the top of window 30. To view a given document returned by the search, the user clicks on the document title. Responsively to the selection, the applet creates an HTTP connection with the remote server and requests the identified document. The remote server servlet retrieves the document from the database and forwards the document to the client computer applet, which displays the document text in window 30.

While one or more preferred embodiments of the invention have been described above, it should be understood that any and all equivalent realizations of the present invention are included within the scope and spirit thereof. Thus, the embodiments depicted are presented by way of example only and are not intended as limitations upon the present invention, and it should be understood by those of ordinary skill in this art that the present invention is not limited to these embodiments since modifications can be made. Therefore, it is contemplated that any and all such embodiments are included in the present invention as may fall within the literal or equivalent scope of the appended claims.

What is claimed is:

1. A process for providing, at a client computer on a web page provided by a host server to the client computer, content that resides on a server that is remote from the host server and the client server over a distributed computer system, said process comprising the steps of:
requesting a web page from the host server and downloading said requested web page to a client computer;
parsing said requested web page on said client computer;
in response to an instruction parsed from said requested web page, downloading executable code to said client computer from a server specified in said instruction;
executing said executable code on said client computer;
responsively to said executable code, downloading content from said remote server to said client computer; and
displaying said content on said requested web page.

2. The process as recited in claim 1, wherein said executable code is downloaded from said remote server.

3. The process as recited in claim 1, wherein said code is configured to establish a connection over said distributed computer system between said client computer and said remote server and wherein said executing step includes automatically requesting predetermined said content from said remote server.

4. The process as recited in claim 1, wherein said code is configured to generate an interface between said client computer and said remote server, wherein said executing step includes establishing said interface on said requested web page, and wherein said content downloaded from said remote server is based upon user requests received by said interface.

5. The process as recited in claim 4, wherein said content downloading and said displaying steps include,
forwarding at least one said user request from said client computer to said remote server,
processing said user request by said remote server,
sending a response to said user request from said remote server to said client computer, and
displaying said response to said user request on said requested web page.

6. The process as recited in claim 1, wherein said requested web page is not refreshed at said displaying step.

7. The process as recited in claim 1, wherein said executable code is a Java byte code.

8. The process as recited in claim 1, wherein said client computer establishes a Hypertext Transfer Protocol (HTTP) connection with said remote server at said content downloading step.

9. A process for querying, from a web page provided by a host server, a server remote from the host server over a distributed computer system and providing, on the web page, content that resides at the remote server, said process comprising the steps of:
requesting a web page from a host server and downloading said requested web page to a client computer;
parsing said requested web page on said client computer;
in response to an instruction parsed from said requested web page, downloading an executable code to the client computer from said remote server;
executing said executable code on said client computer;
responsively to said executable code, establishing a search interface adapted to receive search requests on said requested web page;
in response to a said search request, establishing a connection over the distributed computer system between said client computer and said remote server;
forwarding said search request from said client computer to said remote server over said connection;
querying a database coupled to said remote server for content requested by said search request;
sending a response to said search request from said remote server to said client computer; and
displaying said content on said search interface.

10. The process as recited in claim 9, wherein said requested web page is not refreshed at said displaying step.

11. The process as recited in claim 9, wherein said executable code is a Java byte code.

12. The process as recited in claim 9, wherein said client computer establishes an HTTP connection with said remote server.

13. A system for displaying, at a client computer on a web page provided by a host server to the client computer, content that resides on a server that is remote from the host server and the client computer over a distributed computer system, said system comprising:
a client computer;
a host server configured to communicate with said client computer over the distributed computer system, said host server having a web page residing thereon;
a remote server configured to communicate with said client computer over said distributed computer system;
data coupled to said remote server;
a browser at said client computer configured to request, receive and parse said web page;
first computer program code residing or encapsulated within said web page, said first code being configured to establish, upon execution of said first code by said browser, a communication connection over said distributed computer system between said browser and said remote server and to request the content; and
second computer program code residing at said remote server, said second code being configured to receive said content request from said first code through said connection, to obtain the content from said data responsively thereto and to forward the content to said browser,
wherein said first code is configured to display the content received from said second code on said web page.

14. The system as recited in claim 13, wherein said first code is encapsulated within said web page by instruction code residing at said web page, and wherein said instruction code is configured to establish a communication connection with said remote server and to request said first code from said remote server.

15. The system as recited in claim 13, wherein said first code is configured to establish a connection over said distributed computer system between said client computer and said remote server and to request predetermined said content from said remote server.

16. The system as recited in claim 13, wherein said first code is configured to generate an interface between said client computer and said remote server and to request said content based upon user requests received by said interface.

17. The system as recited in claim 16,
wherein said first code is configured to forward at least one said user request from said client computer to said remote server,
wherein said second code is configured to process said user request and to send said content from said remote server to said client computer, and
wherein said first code is configured to display said content on said requested web page.

18. A process for providing, at a client server on a web page provided by a host server to the client computer, content that resides on a server that is remote from the host server and the client server over a distributed computer system, said process comprising the steps of:
providing an executable code identifiable by an instruction code embedded in said web page;
responsively to downloading of said web page to said client computer, parsing of said instruction by said client computer, and execution of said executable code by said client computer, receiving at said remote server a request from said client computer for said content;
downloading said content from said remote server to said client computer for display by said executable code on said web page.

19. The process as in claim 18, including, following said providing step and prior to said receiving step, downloading said executable code from said remote server to said client computer.

20. The process as in claim 18, wherein said executable code is a Java byte code.

21. The process as in claim 18, wherein said downloading step includes downloading said content over an HTTP connection between said remote server and said client computer.
